(19) United States
(12) Patent Application Publication
(10) Pub. No.: US 2024/0212353 A1
(43) Pub. Date: Jun. 27, 2024

(54) VEHICLE MONITORING SYSTEM

(71) Applicant: TOYOTA JIDOSHA KABUSHIKI KAISHA, Toyota-shi (JP)

(72) Inventors: Shoji SAKAMOTO, Shizuoka-ken (JP); Kazumi TSUCHIYA, Gotemba-shi, (JP); Makoto MATSUSHITA, Ichinomiya-shi (JP); Takeshi TAKEMOTO, Nagoya-shi (JP); Shunsuke SAGARA, Nisshin-shi (JP); Hideaki SHIRAISHI, Tokyo (JP)

(73) Assignee: TOYOTA JIDOSHA KABUSHIKI KAISHA, Toyota-shi (JP)

(21) Appl. No.: 18/488,259

(22) Filed: Oct. 17, 2023

(30) Foreign Application Priority Data
Dec. 22, 2022 (JP) 2022-205469

(51) Int. Cl. G06V 20/52; B60R 16/03; G06V 20/13; G06V 20/62

(52) U.S. Cl. CPC G06V 20/52; B60R 16/03; G06V 20/13; G06V 20/625; G06V 2201/08; G07C 5/008

(57) ABSTRACT

The vehicle monitoring system includes a satellite image acquisition unit that acquires a satellite image captured by the artificial satellite, a vehicle specifying unit that identifies the vehicle based on the satellite image, a parking time calculation unit that calculates a parking time of the identified vehicle based on the satellite image over time, and a left vehicle determination unit that determines the vehicle as an unattended vehicle when the parking time exceeds a predetermined threshold.

### CROSS-REFERENCE TO RELATED APPLICATION

This application claims priority to Japanese Patent Application No. 2022-205469 filed on Dec. 22, 2022, incorporated herein by reference in its entirety.

### BACKGROUND

### 1. Technical Field

The present disclosure relates to a vehicle monitoring system.

### 2. Description of Related Art

Japanese Unexamined Patent Application Publication No. 2017-45211 (JP 2017-45211 A) discloses a technique of a parking monitoring support system that creates information used for parking monitoring, using captured image information of a parking monitoring area. In the parking monitoring support system, based on image information obtained by capturing images of a vehicle at a plurality of times, a parked/stopped state of the vehicle is determined, a parked/stopped time of the vehicle determined to be parked/stopped is calculated, and the parked/stopped time of the vehicle and a parked/stopped position of the vehicle based on the image information are associated with each other and output to notify a monitoring person.

### SUMMARY

Incidentally, in a vehicle monitoring system, it is desirable to monitor a left vehicle even in a place where a monitoring camera or the like is not installed.

An object of the present disclosure is to provide a vehicle monitoring system capable of monitoring a left vehicle even in a place where a monitoring camera or the like is not installed.

A vehicle monitoring system according to claim 1 includes: a satellite image acquisition unit that acquires a satellite image captured by an artificial satellite; a vehicle specifying unit that specifies a vehicle based on the satellite image; a parking time calculation unit that calculates a parking time of the specified vehicle based on the satellite image over time; and a left vehicle determination unit that determines that the vehicle is a left vehicle when the parking time exceeds a predetermined threshold value.

In the vehicle monitoring system according to claim 1, the parking time of the vehicle is calculated from the satellite image by calculating the parking time of the specified vehicle based on the satellite image over time. Then, when the parking time exceeds the predetermined threshold value, the vehicle is determined to be the left vehicle, and thus the left vehicle is determined from the satellite image. Therefore, it is possible to monitor the left vehicle even in a place where a monitoring camera or the like is not installed.

In the vehicle monitoring system according to claim 2, the vehicle monitoring system according to claim 1 further includes: a signal transmitting unit that transmits an ON signal for turning on a vehicle power supply to the vehicle determined to be the left vehicle, when the parking time exceeds the predetermined threshold value; and a failed vehicle determination unit that determines that the vehicle to which the ON signal is transmitted, is a failed vehicle, when the power supply of the vehicle to which the ON signal is transmitted, is not turned on.

In the vehicle monitoring system according to claim 2, determination is made whether the vehicle is parked in a failed state by including a failed vehicle determination unit that determines that the vehicle to which the ON signal is transmitted, is a failed vehicle, when the power supply of the vehicle to which the ON signal is transmitted, is not turned on. Therefore, it is possible to know whether the determined left vehicle is a failed vehicle.

In the vehicle monitoring system according to claim 3, the vehicle monitoring system according to claim 1 or 2 further includes: a license plate specifying unit that specifies a license plate based on the satellite image; a number acquisition unit that acquires the number of the specified license plate; and a vehicle information acquisition unit that acquires information about the vehicle based on the acquired number.

In the vehicle monitoring system according to claim 3, it is possible to easily acquire the information about the vehicle by including the vehicle information acquisition unit that acquires the information about the vehicle based on the number acquired based on the satellite image.

As described above, according to the vehicle monitoring system of the present disclosure, it is possible to monitor the left vehicle even in a place where a monitoring camera or the like is not installed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram schematically illustrating an entire system according to a first embodiment;

FIG. 2 is a block diagram illustrating a functional configuration of the parking monitoring device according to the first embodiment;

FIG. 3 is a flow chart showing a flow of a process performed by the parking monitoring device according to the first embodiment; and

FIG. 4 is a flow chart showing a flow of a process performed by the parking monitoring device according to of the second embodiment.

### DETAILED DESCRIPTION OF EMBODIMENTS

### First Embodiment

Hereinafter, the vehicle monitoring system 1 including the parking monitoring device 20 according to the first embodiment will be described with reference to the drawings. The vehicle monitoring system 1 according to the first embodiment will be described as an example of a system that manages a vehicle 10 that has been left unattended.

### Configuration of the Vehicle Monitoring System 1

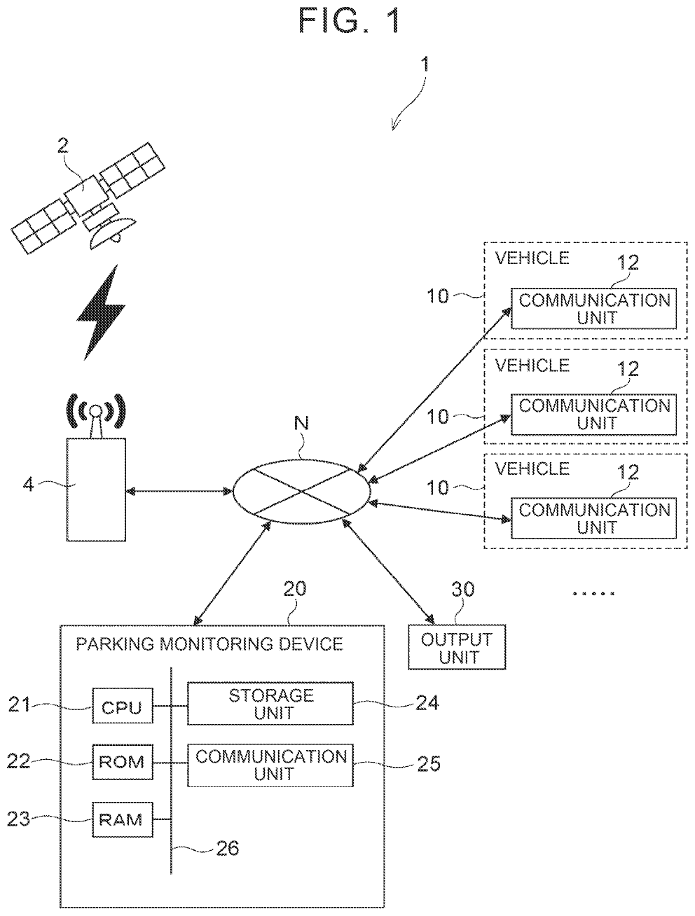

As illustrated in FIG. 1, the vehicle monitoring system 1 includes an artificial satellite 2, a server 4, a plurality of vehicles 10, a parking monitoring device 20, and an output unit 30. The parking monitoring device 20, the server 4, the output unit 30, and the vehicles 10 are connected to each other via a network N and can communicate with each other.

### Artificial Satellite 2

The artificial satellite 2 circulates on the satellite orbit of the earth at a predetermined cycle, and photographs the earth. The artificial satellites 2 can also be geostationary satellites that revolve at the same cycle as the earth's rotation cycle.

### Server 4

The server 4 is a server computer, and acquires a satellite image captured by the artificial satellite 2 from the artificial satellite 2.

### Vehicle 10

The vehicle 10 includes a communication unit 12. As the communication by the communication unit 12, for example, standards such as Controller Area Network (CAN), Ethernet (registered trademark), Long Term Evolution (LTE), Fiber Distributed Data Interface (FDDI), and Wi-Fi (registered trademark) are used. A license plate (vehicle registration number mark) in which a license for identifying each vehicle 10 is described is attached to the vehicle 10. Note that the license plate can also be attached to a position (for example, the upper surface of the roof panel) that is easily imaged in the satellite image captured by the artificial satellite 2.

### Parking Monitoring Device 20

The parking monitoring device 20 is installed outside the vehicle 10, for example. The parking monitoring device 20 is configured to be able to acquire various kinds of information from the server 4 and the vehicle 10 via the network N.

### Output Unit 30

The output unit 30 outputs information from the parking monitoring device 20, and can be, for example, a mobile terminal, a PC terminal, a printer, or the like.

### Hardware Configuration of the Parking Monitoring Device 20

As illustrated in FIG. 1, the parking monitoring device 20 includes a Central Processing Unit (CPU) 21, a Read Only Memory (ROM) 22, a Random Access Memory (RAM) 23, a storage unit 24, and a communication unit 25. The components are communicably connected to each other via a bus 26.

The CPU 21 is a central processing unit that executes various programs and that controls various units. CPU 21 reads the program from ROM 22 or the storage unit 24, and executes the program using RAM 23 as a working area. CPU 21 performs control of the above-described configurations and various arithmetic processes in accordance with a ROM 22 or a program recorded in the storage unit 24.

The ROM 22 stores various programs and various data. The RAM 23 temporarily stores a program or data as a work area.

The storage unit 24 is configured by a storage device such as a Hard Disk Drive (HDD), Solid State Drive (SSD), or a flash memory, and stores various programs and various data. The storage unit 24 stores a program for executing a parking monitoring process to be described later.

The communication unit 25 is an interface for communicating with the vehicle 10, the output unit 30, and other devices via the network N. As the communication by the communication unit 25, for example, standards such as Controller Area Network (CAN), Ethernet (registered trademark), Long Term Evolution (LTE), Fiber Distributed Data Interface (FDDI), and Wi-Fi (registered trademark) are used.

### Functional Configuration of the Parking Monitoring Device 20

The satellite image captured by the artificial satellite 2 is input to the parking monitoring device 20 via the network N, and the processing information in which the parking monitoring process is executed in the parking monitoring device 20 is output to the output unit 30 via the network N. In the parking monitoring device 20, CPU 21 executes a parking monitoring process in accordance with a ROM 22 or a program recorded in the storage unit 24.

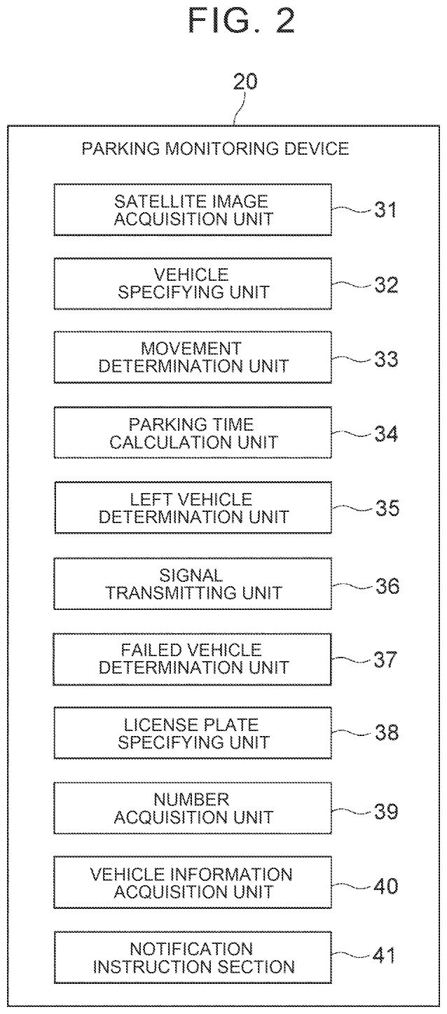

As illustrated in FIG. 2, the parking monitoring device 20 functionally includes a satellite image acquisition unit 31, a vehicle specifying unit 32, a movement determination unit 33, a parking time calculation unit 34, a left vehicle determination unit 35, a signal transmitting unit 36, a failed vehicle determination unit 37, a license plate specifying unit 38, a number acquisition unit 39, a vehicle information acquisition unit 40, and a notification instruction unit 41.

The satellite image acquisition unit 31 acquires a satellite image captured by the artificial satellite 2. The vehicle specifying unit 32 identifies the vehicle 10 based on the satellite image, for example, by image recognition.

The movement determination unit 33 determines whether or not the vehicle 10 identified by the vehicle specifying unit 32 has moved based on the satellite image with time. When the vehicle 10 is shown in the past satellite image and the vehicle 10 is not shown in the current satellite image or when the vehicle 10 is shown in a different position, the movement determination unit 33 determines that the vehicle 10 has moved. On the other hand, when the vehicle 10 is shown in the past satellite image and the vehicle 10 is also shown in the current satellite image at the same position, the movement determination unit 33 determines that the vehicle 10 is not moving.

The parking time calculation unit 34 calculates the parking time of the specified vehicle 10 on the basis of the satellite image with time. For example, when the vehicle 10 is not moved in the satellite image from 100 hours before to the present, the parking time calculation unit 34 calculates the parking time of the vehicle 10 as 100 hours. That is, the parking time calculation unit 34 calculates the time during which the vehicle 10 is not moved in the satellite image.

The left vehicle determination unit 35 determines whether or not the vehicle is a neglected vehicle based on the parking time. When the parking time exceeds a predetermined threshold (time), the left vehicle determination unit 35 determines that the vehicle 10 is a neglected vehicle. When the parking time does not exceed the predetermined threshold, the left vehicle determination unit 35 determines that the vehicle 10 is not the neglected vehicle. The predetermined threshold value can be appropriately changed depending on, for example, a place where the neglected vehicle is monitored, and can be, for example, 100 hours.

The signal transmitting unit 36 transmits an ON signal for turning ON the power of the vehicle 10 to the vehicle 10 determined to be a left vehicle when the parking period exceeds a predetermined threshold. ON signal may be, for example, a signal that turns ON the ignition switch.

The failed vehicle determination unit 37 determines whether or not the vehicle 10 is a failed vehicle. When the vehicle 10 to which ON signal is transmitted is turned ON, the failed vehicle determination unit 37 determines that the vehicle 10 to which ON signal is transmitted is not a failed vehicle. When the vehicle 10 to which ON signal is transmitted does not turn ON, the failed vehicle determination unit 37 determines that the vehicle 10 to which ON signal is transmitted is a failed vehicle. When the vehicle 10 is not powered ON, a case where communication with the vehicle 10 is disabled is included.

The license plate specifying unit 38 specifies the license plate based on the satellite image, for example, by image recognition. The number acquisition unit 39 acquires the license of the specified license plate by, for example, character recognition.

The vehicle information acquisition unit 40 acquires information related to the vehicle 10 based on the acquired number. It is assumed that the information on the vehicle 10 includes information of the owner of the vehicle 10. The information of the owner of the vehicle 10 includes the name of the owner and the telephone number of the owner.

The notification instruction unit 41 gives an instruction to output the information processed by the parking monitoring process to the output unit 30.

### Flow of Parking Monitoring Process

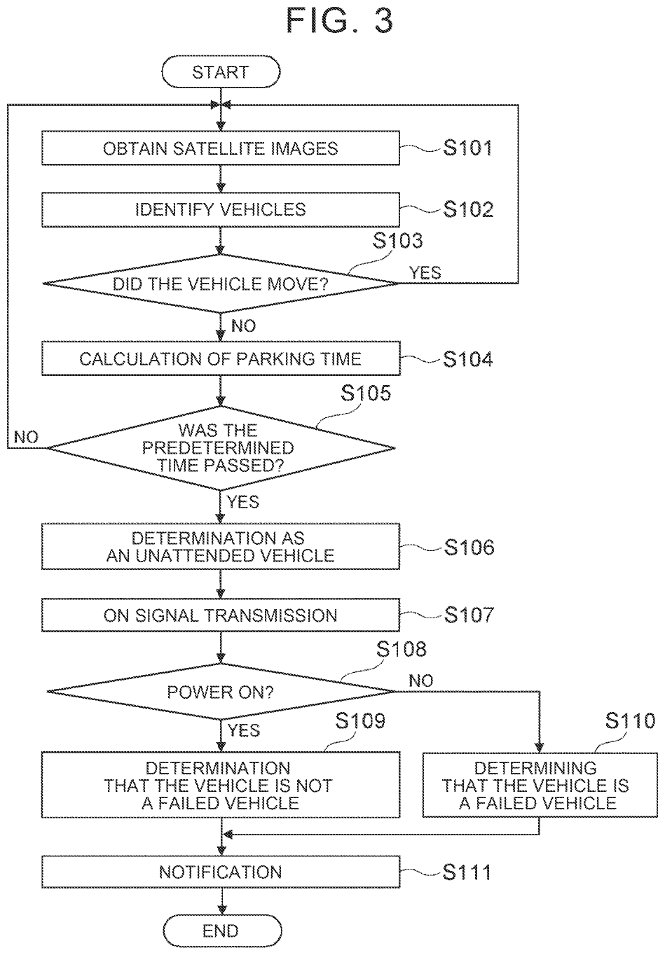

As illustrated in FIG. 3, when the parking monitoring process is started, the satellite image acquisition unit 31 acquires the satellite image captured by the artificial satellite 2 (S101). Next, the vehicle specifying unit 32 identifies the vehicle 10 based on the satellite-image (S102).

Next, the movement determination unit 33 determines whether or not the vehicle 10 identified by the vehicle specifying unit 32 has moved based on the satellite images over time (S103). When it is determined that the vehicle 10 specified by the vehicle specifying unit 32 has moved (YES in S103), S101 returns. On the other hand, when it is determined that the vehicle 10 specified by the vehicle specifying unit 32 is not moving (NO in S103), S104 proceeds.

Proceeding to S104, the parking time calculation unit 34 calculates the parking time of the specified vehicle 10 on the basis of the satellite-images with time.

Next, the left vehicle determination unit 35 determines whether or not the parking time exceeds a predetermined time (S105). When it is determined that the parking time exceeds the predetermined time (YES in S105), the left vehicle determination unit 35 determines that the vehicle 10 is a left vehicle (S106), and proceeds to S107. On the other hand, if it is determined that the parking time does not exceed the predetermined time (NO in S105), the process returns to S101.

In S107, the signal transmitting unit 36 transmits (S107) an ON signal for turning ON the power of the vehicle 10 to the vehicle 10 determined to be a neglected vehicle.

Next, the failed vehicle determination unit 37 determines whether or not the power supply of the vehicle 10 to which ON is transmitted is turned ON (S108). When it is determined that the power supply of the vehicle 10 to which ON signal has been transmitted is turned ON (YES in S108), it is determined that the vehicle 10 to which ON signal has been transmitted is not a failed vehicle (S109), and the process proceeds to S111. On the other hand, when it is determined that the vehicle 10 to which ON signal has been transmitted is not turned S108 (NO), it is determined that the vehicle 10 to which ON signal has been transmitted is a failed vehicle (S110), and the process proceeds to S111.

When proceeding to S111, the notification instruction unit 41 gives an instruction to output information indicating whether or not the vehicle is a neglected vehicle and information indicating whether or not the vehicle is a failed vehicle to the output unit 30 (S111), and ends the parking monitoring process.

### Effects

The vehicle monitoring system 1 according to the first embodiment includes a satellite image acquisition unit 31 that acquires a satellite image captured by the artificial satellite 2, a vehicle specifying unit 32 that identifies the vehicle 10 based on the satellite image, a parking time calculation unit 34 that calculates a parking time of the specified vehicle 10 based on the satellite image over time, and a left vehicle determination unit 35 that determines the vehicle 10 as an unattended vehicle when the parking time exceeds a predetermined threshold (see FIG. 2).

The parking time of the vehicle 10 is calculated from the satellite image by calculating the specified parking time of the vehicle 10 based on the satellite image with time. When the parking time exceeds a predetermined threshold value, the vehicle 10 is determined to be an unattended vehicle, and the unattended vehicle is determined from the satellite image. Therefore, it is possible to monitor the left vehicle even in a place where a monitoring camera or the like is not installed.

The vehicle monitoring system 1 according to the first embodiment includes a signal transmitting unit 36 that transmits a ON signal for turning ON the vehicle power when the parking period exceeds a predetermined threshold value to the vehicle 10 determined to be a neglected vehicle, and a failed vehicle determination unit 37 that determines the vehicle 10 to which ON signal is transmitted as a failed vehicle when the vehicle 10 to which ON signal is transmitted is not turned ON (see FIG. 2).

When the vehicle 10 to which ON signal is transmitted does not turn ON, by comprising a failed vehicle determination unit 37 for determining the vehicle 10 to which ON signal is transmitted as a failed vehicle, whether the vehicle 10 is parked in a state of failure is determined. Therefore, it is possible to know whether the determined left vehicle is a failed vehicle.

### Second Embodiment

The vehicle monitoring system of the second embodiment is different from the vehicle monitoring system of the first embodiment in that the flow of the parking monitoring process is different. Explanations of the same or equivalent parts as those described in the first embodiment will be described using the same terms or reference numerals.

### Flow of Parking Monitoring Process

Since the processing from S201 to S210 is the same processing from S101 to S110 in the first embodiment, the processing from S211 onward will be described below.

In S211, the license plate specifying unit 38 specifies the license plate of the vehicle 10 determined to be the specified neglected vehicle based on the satellite images (S211). Next, the number acquisition unit 39 obtains the license of the identified license plate (S212). Next, the vehicle information acquisition unit 40 acquires information related to the vehicle 10 based on the acquired number (S213).

Next, the notification instruction unit 41 gives an instruction to output information that is a left-behind vehicle, information on whether or not the vehicle is a failed vehicle, and information on the vehicle 10 to the output unit 30 (S214), and ends the parking monitoring process.

### Effects

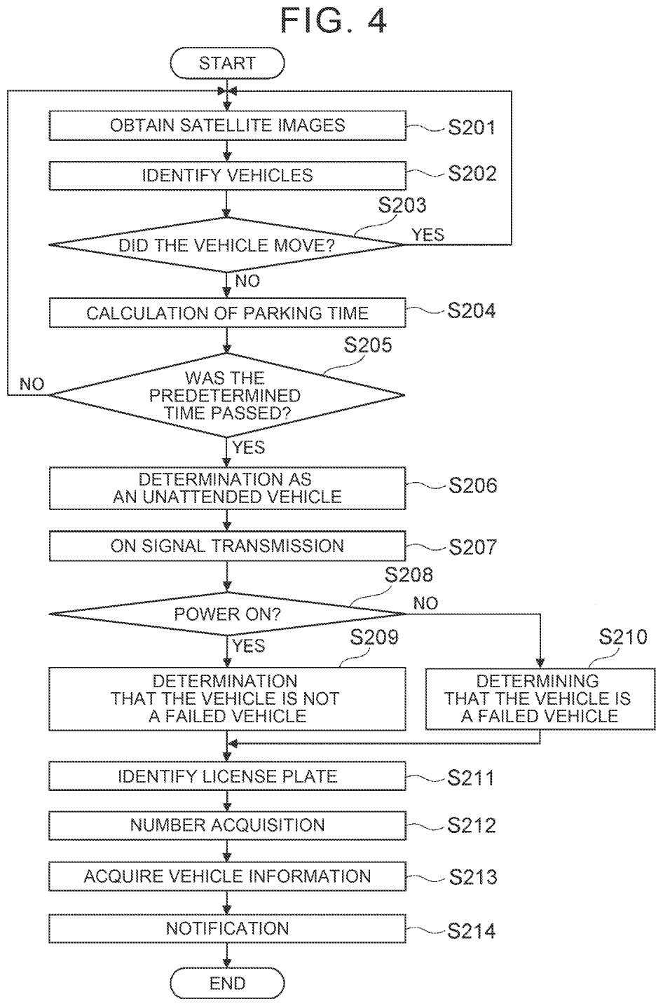

The vehicle monitoring system 1 according to the second embodiment includes a license plate specifying unit 38 that specifies a license plate based on the satellite image, a number acquisition unit 39 that acquires the license of the specified license plate, and a vehicle information acquisition unit 40 that acquires information about the vehicle 10 based on the acquired license (see FIG. 4).

By providing the vehicle information acquisition unit 40 that acquires information on the vehicle 10 based on the number acquired based on the satellite image, it is possible to easily acquire information on the vehicle 10.

Note that other configurations and operational effects are substantially the same as those of the first embodiment, and thus description thereof will be omitted.

The vehicle monitoring system according to the embodiment has been described above based on the first embodiment and the second embodiment. However, the specific configuration is not limited to these embodiments, and changes in design and the like are allowed without departing from the gist of the disclosure according to each claim of the claims.

In the first embodiment, an example has been described in which the vehicle monitoring system 1 determines a left vehicle and further determines whether or not the vehicle is a failed vehicle. However, the vehicle monitoring system does not need to determine whether the vehicle is a failed vehicle.

In the first embodiment and the second embodiment, various processors other than CPU 21 may execute the process executed by CPU 21 reading the program. Examples of the processor include a Programmable Logic Device (PLD) in which a circuit configuration can be changed after manufacturing of Field-Programmable Gate Array (FPGA), and the like, and a dedicated electric circuit that is a processor having a circuit configuration designed exclusively for executing a particular process such as Application Spec Integrated Circuit (ASIC), and the like. In addition, the above processes may be executed by one of these various processors, or may be executed by a combination of two or more processors of the same kind or different kinds. For example, the processes may be executed by a plurality of FPGAs, a combination of the CPU and the FPGA, and the like. Furthermore, the hardware structure of each of the various processors is, more specifically, an electric circuit in which circuit elements such as semiconductor elements are combined.

In the first embodiment and the second embodiment, various data are stored in the storage unit 24, but the present disclosure is not limited thereto. For example, a non-transitory recording medium such as Compact Disk (CD), Digital Versatile Disk (DVD), and Universal Serial Bus (USB) memories may be used as the storage unit. In this case, various programs, data, and the like are stored in these recording media.

The flow of the processing described in the first embodiment and the second embodiment is an example, and unnecessary steps may be deleted, new steps may be added, or the processing order may be changed without departing from the gist.

What is claimed is:

1. A vehicle monitoring system comprising:
a satellite image acquisition unit that acquires a satellite image captured by an artificial satellite;
a vehicle specifying unit that specifies a vehicle based on the satellite image;
a parking time calculation unit that calculates a parking time of the specified vehicle based on the satellite image over time; and
a left vehicle determination unit that determines that the vehicle is a left vehicle when the parking time exceeds a predetermined threshold value.

2. The vehicle monitoring system according to claim 1, further comprising:
a signal transmitting unit that transmits an ON signal for turning on a vehicle power supply to the vehicle determined to be the left vehicle, when the parking time exceeds the predetermined threshold value; and
a failed vehicle determination unit that determines that the vehicle to which the ON signal is transmitted, is a failed vehicle, when the power supply of the vehicle to which the ON signal is transmitted, is not turned on.

3. The vehicle monitoring system according to claim 1, further comprising:
a license plate specifying unit that specifies a license plate based on the satellite image;
a number acquisition unit that acquires the number of the specified license plate; and
a vehicle information acquisition unit that acquires information about the vehicle based on the acquired number.
